(19) United States
(12) Patent Application Publication
(10) Pub. No.: US 2022/0243840 A1
(43) Pub. Date: Aug. 4, 2022

(54) LIGHT-TOUCH WATER-SAVING VALVE

(71) Applicant: SIAN-CING SHIH, Taipei City (TW)

(72) Inventor: SIAN-CING SHIH, Taipei City (TW)

(21) Appl. No.: 17/560,312

(22) Filed: Dec. 23, 2021

(30) Foreign Application Priority Data
Feb. 4, 2021 (TW) 110201407

(51) Int. Cl. F16K 31/524; F16K 21/06

(52) U.S. Cl. CPC F16K 31/52408; F16K 21/06

(57) ABSTRACT

A light-touch water-saving valve of the invention uses the conversion of steel balls for various controls. First, a shifting steel ball are used to transfer the transverse shear force of a guide plate into the longitudinal thrust to open and close the valve, and then a constant-flow steel ball is used to clamp a valve seat to fix the valve to achieve a constant flow control. When a user releases a brake rod, the valve is automatically closed by a restoration spring. At the same time, the shifting steel ball is pressed by a packing spring, and then the ball grooves on the two sides of the guide plate are pressed to lock the valve to a normally opening operation.

### FIELD OF THE INVENTION

The present invention uses steel balls and springs for various water-saving controls. First, a shifting steel ball is used to transfer the transverse shear force of a guide plate into a longitudinal thrust to open and close the valve, and then a restoration sleeve is used to shift a constant-flow steel ball to clamp a valve seat to fix the valve to achieve a constant flow control. When a user releases a brake rod, the valve will be closed automatically and immediately by the action of a restoration spring. When the user pushes the brake rod to a horizontal position, the steel ball is pushed by a packing spring to lock the two ball grooves of the guide plate to achieve a normally opening operation.

### BACKGROUND OF THE INVENTION

Water resources are becoming more precious due to the population expansion. So far, the only devices that can save water are electronic induction devices. People are not willing to use the electronic induction devices because of the high prices, the difficulty of installation and maintenance, and the electricity consumption. After search, there is a patent document (CN102686814A) providing a mechanical water-saving device titled apparatus for saving tap water. The mechanical water-saving device is installed at a water outlet of a faucet. The valve is opened and closed by a lower handle through the built-in structure. The fixing method uses the principle of a telescopic ballpoint pen which needs a press to open and another press to close. The structure is very complicated, and it needs to be manufactured with a mold. In order to be more perfect and practical, there is a need to improve.

### SUMMARY OF THE INVENTION

The invention provides a light-touch water-saving valve capable of automatically turning off water. The light-touch water-saving valve is used to lock the valve to achieve a constant flow control and a normally open operation.

An embodiment of the invention provides a light-touch water-saving valve capable of automatically turning off water includes a connecting head, a combination cover, a valve rod, a valve rubber ring, a guide plate, a guide pin and a brake rod, wherein the upper end of the connecting head has threads for installing on a faucet water outlet, the lower end of the connecting head has threads for integrating with the combination cover, a support frame is installed in the combination cover, a valve seat and a packing spring are arranged in the upper end of the support frame, the valve seat and the packing spring are connected to the valve rod arranged in the connecting head and the valve rubber ring arranged on the outside of the connecting head to compress a water inlet of the connecting head, a constant-flow steel ball is installed at the middle part of the support frame, a restoration sleeve and a restoration spring are sleeved on the periphery of the support frame to use as a constant flow control, a shifting steel ball is arranged at a lower end of the support frame, the support frame and the restoration sleeve extend out of the combination cover at the same time, the guide pin arranges the guide plate at the lower end of the support frame, the guide plate pushes against the shifting steel ball, the brake rod is fixed to the guide plate, and a user pushes the brake rod for various water operations.

In an embodiment of the present invention, the light-touch water-saving valve capable of automatically turning off water is characterized in that the brake rod is fixed to the guide plate by a rivet.

In an embodiment of the present invention, the light-touch water-saving valve capable of automatically turning off water is characterized in that the valve further includes a buffer steel ball located between the constant-flow steel ball and the valve seat.

The present invention uses the restoration spring to automatically close the valve, and at the same time uses the shifting steel ball to transfer a transverse shear force into a longitudinal thrust, so as to obtain the minimum shift angle to open and close the valve. Then, the present invention uses the restoration sleeve to shift the constant-flow steel ball to clamp the valve seat to achieve the constant flow control and lock the valve. When the user releases the brake rod, the valve will be closed automatically and immediately by the action of the restored spring. When the user moves the brake rod to a horizontal position, the steel ball is pushed by the packing spring and clamp the ball grooves on the two sides of the guide plate to achieve a normally open operation.

The above description is only an overview of the technical solution of the present invention. In order to understand the technical means of the present invention more clearly, the invention can be implemented in accordance with the content of the specification. Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The present invention will become more readily apparent to those ordinarily skilled in the art after reviewing the following detailed description and accompanying drawings, in which:

FIG. 1 is a cross-sectional diagram of an overall structure of a light-touch water-saving valve according an embodiment of the present invention;

FIG. 2 is a cross-sectional diagram of a structure of a light-touch water-saving valve in a constant flow control according an embodiment of the present invention;

FIG. 3 is a schematic diagram for illustrating a displacement of a shifting steel ball when water is being used according to an embodiment of the present invention;

FIG. 4 is a schematic diagram for illustrating a locking of a shifting steel ball in a normally open operation according to an embodiment of the present invention;

FIG. 5 is a cross-sectional diagram of the improved-manufactured support frame;

FIG. 6 is a cross-sectional diagram of the improved-manufactured connecting head; and

FIG. 7 is a cross-sectional diagram of the improved-manufactured combination cover.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

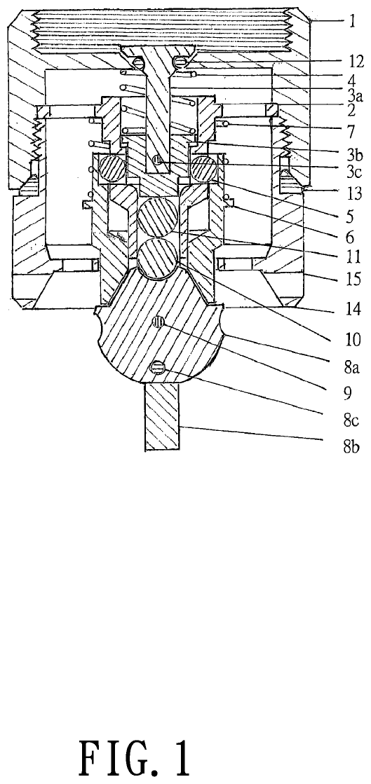

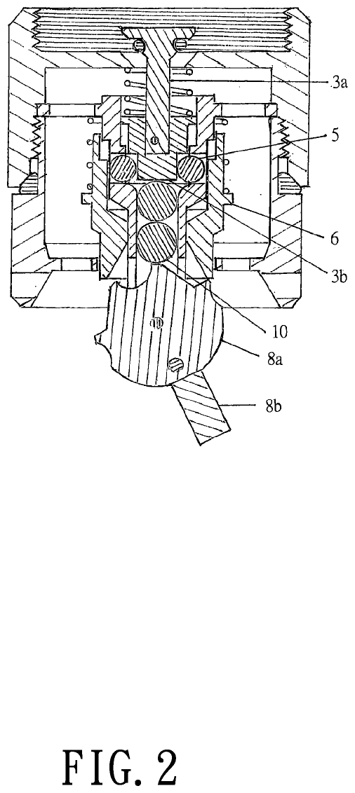

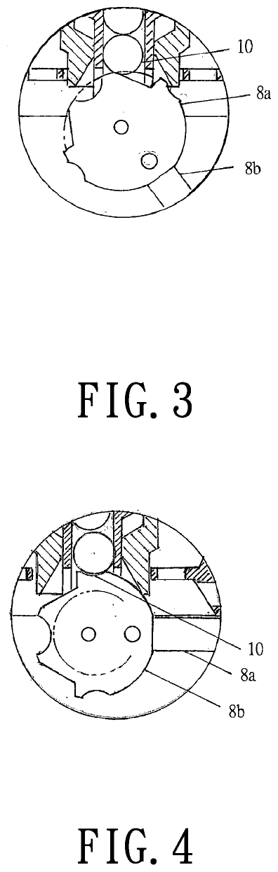

FIG. 1 is a cross-sectional diagram of an overall structure of a light-touch water-saving valve according an embodiment of the present invention. FIG. 2 is a cross-sectional diagram of a structure of a light-touch water-saving valve in a constant flow control according an embodiment of the present invention. FIG. 3 is a schematic diagram for illustrating a displacement of a shifting steel ball when water is being used according to an embodiment of the present invention. FIG. 4 is a schematic diagram for illustrating a locking of a shifting steel ball in a normally open operation according to an embodiment of the present invention. Please refer to FIGS. 1 to 4. The light-touch water-saving valve capable of automatically turning off water of this embodiment includes a connecting head 1, a combination cover 14, a valve rod 3a, a valve rubber ring 12, a guide plate 8a, a guide pin 9 and a brake rod 8b. The upper end of the connecting head 1 has threads for installing the light-touch water-saving valve to a faucet water outlet. The lower end of the connecting head 1 has threads for integrating with the combination cover 14. A support frame 2 is installed in the combination cover 14. A valve seat 3b and a packing spring 4 are arranged at the inner upper end of the support frame 2. The valve seat 3b and the packing spring 4 are connected to the valve rod 3a arranged in the connecting head 1 and the valve rubber ring 12 arranged on the outside of the connecting head 1 to compress a water inlet of the connecting head 1. A constant-flow steel ball 5 is installed at the middle part of the support frame 2. A restoration sleeve 6 and a restoration spring 7 are sleeved on the periphery of the support frame 2 to be used as a constant flow control. A shifting steel ball 10 is arranged at a lower end of the support frame 2. The support frame 2 and the restoration sleeve 6 extend out of the combination cover 14 at the same time. The guide pin 9 arranges the guide plate 8a at the lower end of the support frame 2. The guide plate 8a is used to push against the shifting steel ball 10. The brake rod 8b is fixed to the guide plate 8a. A user can push the brake rod 8b for various water operations.

The light-touch water-saving valve capable of automatically turning off water of this embodiment is a cylindrical structure and may be installed at a water outlet of a faucet. The light-touch water-saving valve uses the packing spring 4 to push the valve seat 3b to drive the valve rod 3a to press the valve rubber ring 12 to close the water flow (please refer to FIG. 1). When the user pushes the brake rod 8b, the guide plate 8a pushes the shifting steel ball 10 and a buffer steel ball 11 (the buffer steel ball 11 is not necessary and can be replaced by a lengthened valve seat 3b) upward at the same time. Then, the valve rod 3a is pushed through the valve seat 3b to turn on the water flow. Meanwhile, the guide plate 8a pushes the restoration sleeve 6 upward, so as to push a constant-flow steel ball 5 to shift to clamp the valve seat 3b. Thus, the valve rod 3a is fixed and a constant flow is achieved. As a result, the water flow will not be affected even when the brake rod 8b is moved significantly (please refer to FIG. 2). When the user releases the brake rod 8b, the valve rod 3a will return to the original position and automatically turn off the water flow due to the force of the restoration spring 7 and the packing spring 4 (please refer to FIG. 1). When the user continues to push the brake rod 8b, the shifting steel ball 10 will begin to slide downward (please refer to FIG. 3) to disengage with the force of the packing spring 4. Then, the shifting steel ball 10 can slide easily at the V-shaped part of the guide plate 8a. When the user pushes the brake rod 8b to a horizontal position, the guide plate 8a will again push the shifting steel ball 10 upward into a ball groove, and the shifting steel ball 10 will be compressed by the packing spring 4 at the same time to achieve the normally open operation (please refer to FIG. 4).

The assembly of the light-touch water-saving valve is divided into upper and lower parts. First, insert the valve rod 3a into the connecting head 1, sleeve the packing spring 4 and the valve seat 3b, and use the valve pin 3c to rivet the valve rod 3a and the valve seat 3b for the following step. Then, sleeve the restoration spring 7 and the restoration sleeve 6 on the support frame 2 and pass through the combination cover 14, and rivet the guide pin 9 into the guide plate 8a. Then, put on the leak-proof rubber ring 13, the shifting steel ball 10, the buffer steel ball 11, and the constant-flow steel ball 5. Then, lock the structure of the connecting head 1 with the valve installed, use a screwdriver to insert the tightening hole 15 to tighten the leak-proof rubber ring 13. Finally, put on the brake rod 8b riveted into the guide plate 8a by the rivet 8c and push it to the normally open position. Thus, the assembly is completed by putting the valve rubber ring 12 from the outer side of the connecting head 1.

In order to save manufacture materials and improve practical value, the light-touch water-saving valve of the present invention can be manufactured in combination:

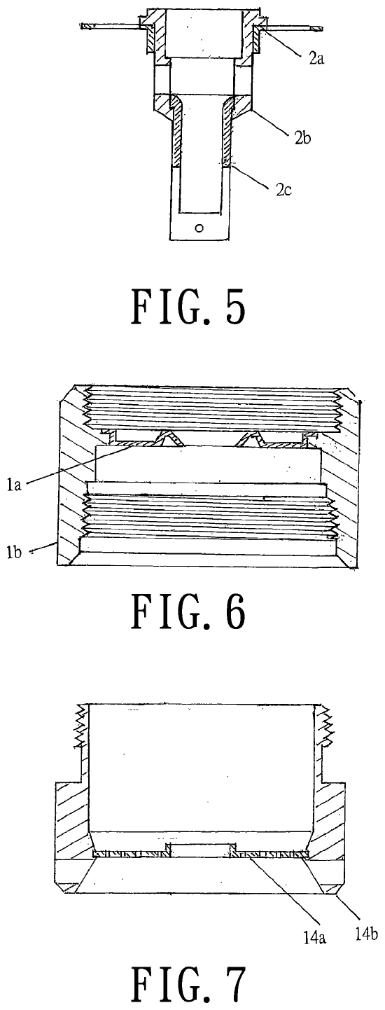

1. The structure of the support frame 2 is divided into the three parts of the positioning plate 2a, the support seat 2b, and the brake frame 2c. The plane contacting the outer edge can be assembled by the positioning plate 2a rolled with the center hole and the water flow hole by the round iron sheet. The supporting guide plate 8a is divided into upper and lower parts for the manufacture of the support seat 2b and the brake frame 2c. The brake frame 2c extends out the support seat 2b and is used for the guide pin 9 to fix the guide plate 8a (as shown in FIG. 5). Thus, the brake rod 8b can be rotated and moved arbitrarily within the range of the hemisphere, thereby improving the practicability of the device.

2. The structure of a water inlet part of the connecting head 1 may be rolled out of a water inlet shape with a circular iron plate, and then the outer edge of the water inlet part is formed into a dish shape as a water inlet cover 1a, which is directly riveted into a tubular connecting seat lb. Thus, a hexagonal tubular material can be used to save material (shown as FIG. 6).

3. The structure of a water outlet part of the combination cover 14 may also be rolled out of a central hole and the water outlet hole with a circular iron plate to form a water outlet plate 14a to provide spray water flow, which is then riveted into a tubular combination seat 14b, thereby saving material and improving water saving efficiency (shown as FIG. 7).

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light-touch water-saving valve capable of automatically turning off water, comprising:
a connecting head;
a combination cover;
a valve rod;
a valve rubber ring;
a guide plate;
a guide pin; and
a brake rod,
wherein an upper end of the connecting head has threads for installing on a faucet water outlet, a lower end of the connecting head has threads for integrating with the combination cover, a support frame is installed in the combination cover, a valve seat and a packing spring are arranged at an inner upper end of the support frame, the valve seat and the packing spring are connected to the valve rod arranged in the connecting head and the valve rubber ring arranged on an outside of the connecting head to compress a water inlet of the connecting head, a constant-flow steel ball is installed at a middle part of the support frame, a restoration sleeve and a restoration spring are sleeved on a periphery of the support frame to be used as a constant flow control, a shifting steel ball is arranged at a lower end of the support frame, the support frame and the restoration sleeve extend out of the combination cover at the same time, the guide pin the guide plate at the lower end of the support frame, the guide plate is used to push against the shifting steel ball, the brake rod is fixed to the guide plate, and a user can push the brake rod for various water operations.

2. The light-touch water-saving valve capable of automatically turning off water according to claim 1, wherein the brake rod is fixed to the guide plate by a rivet.

3. The light-touch water-saving valve capable of automatically turning off water according to claim 1, further comprising a buffer steel ball arranged between the constant-flow steel ball and the valve seat.
